(19) United States
(12) Patent Application Publication
(10) Pub. No.: US 2008/0267200 A1
(43) Pub. Date: Oct. 30, 2008

(54) Network Router Based on Combinatorial Designs

(76) Inventors: Simon Berkovich, Rockville, MD (US); Alexander Kuznetsov, Rockville, MD (US)

Correspondence Address: SMITH, GAMBRELL & RUSSELL, 1130 CONNECTICUT AVENUE, N.W., SUITE 1130, WASHINGTON, DC, 20036, US

(21) Appl. No.: 11/884,520

(22) PCT Filed: Feb. 14, 2006
(86) PCT No.: PCT/US06/05017

§ 371 Date: Aug. 17, 2007

Related U.S. Application Data
(60) Provisional application No. 60/653,632, filed on Feb. 17, 2005.

(51) Int. Cl. H04L 12/56; G06F 15/16

(52) U.S. Cl. 370/401; 709/249

(57) ABSTRACT

A router architecture based on combinatorial design. The router includes a plurality of input channels; a plurality of processors; a plurality of output channels; and buses interconnecting the input channels, processors, and output channels in a manner such that each pair of channels exists in only a pre-selected number of processor (pairwise balance property) and subsets of output channels, connected to processing elements. covers entire set of output channels (full covering property).

### RELATED APPLICATIONS

This application claims priority based upon Provisional U.S. Application 60/653,632 filed Feb. 17, 2005.

### BACKGROUND AND SUMMARY

The following numbered references provide theoretical background for the inventions described and claimed herein.
[1] C. J. Colbourn and P. C. van Oorschot. Applications of combinatorial designs in computer science. ACM Computing Surveys, 21:223-250, 1989.
[2] C. L. Liu. Introduction to Combinatorial Mathematics. McGraw-Hill Book Company, New York, 1968[3] David Clark and Joseph Pasquale. Strategic directions in networks and telecommunications. ACM Computing Surveys (CSUR), 28:679-690, December 1996.
[4] Douglas E. Corner. Computer Networks and Internets: with Internet Applications. Prentice Hall, 2001.
[5] S. Keshav and Rosen Sharma. Issues and trends in router design. IEEE Communications Magazine, pages 144-151, May 1998.
[6] G. Trotter. Terminology for forwarding information base (fib) based router performance. RFC3222, December 2001.
[7] W. E. Leland, M. S. Taqqu, W. Willinger, and D. V. Wilson. On the self-similar nature of ethernet traffic (extended version). IEEE/ACM Transactions on Networking, 2:1-15, February 1994.
[8] Joseph Yu and Ngai Hui. Switching and Traffic Theory for Integrated Broadband Networks. Springer, January 1990.
[9] J. Cowie, A. Ogielski, B. Premore, and Y. Yuan. Internet worms and global routing instabilities. Renesys Corporation, 2002. Note: Global routing instabilities statistics during Internet worms propagation. Downloaded Dec. 8, 2005.
[10] A. Asthana, C. Delph, H. V. Jagadish, and P. Krzyzanowski. Towards a gigabit IP router. Journal of High Speed Networks, 1(4):281-288, 1992.
[11] N. McKeon. Fast switched backplane for a gigabit switched router. Technical Report Unpblished whitepaper, 1998.
[12] S. Y. Berkovich. Multiprocessor interconnection network using pairwise balanced combinatorial designs. Information Processing Letters, 50:217-222, 1994.
[13] S. Y. Berkovich and Lin ching Chang. A multiprocessor network arranging replicated objects in pairwise balanced combinatorial designs, journal of circuits. Systems and Computers, 6:85-91, 1996.
[14] S. Berkovich and E. Berkovich. A combinatorial architecture for instruction-level parallelism. Microprocessors and Microsystems, 22:23-31, 1998.

Inventions described herein relate to the application of combinatorial designs to parallel router architecture design. They include both methods of determining router architecture and the architectures themselves. The inventions represent a new type of parallel router architecture based on a combinatorial arrangement of processing and switching elements.

Combinatorial design is a mathematical construction which presents a collection of subsets of a given set, selected in accordance with some prescribed condition. Initial applications of the combinatorial approach were mostly related to the planning of statistical experiments. Subsets of the trials are arranged to randomize influence of a multiplicity of causes. More recently, the utilization of combinatorial designs acquires growing importance in many areas of computer science such as network operations, computer organization, and information retrieval [1]. Realization of computer interconnections can effectively exploit a particular type of combinatorial designs, called the balanced incomplete block (BIB) designs [2], in which elements of a set are distributed into a collection of subsets having a pairwise balanced property.

The property of pairwise balanced distribution of the elements means that taking any pair of elements of a set, it is always possible to find a particular subset containing this pair of elements. A BIB design is characterized by five parameters: b—the number of blocks (subsets),
v—the number of elements in the whole set,
r—the number of blocks containing each element,
k—the number of elements in each block, and
λ—the number of blocks in which every pairs of elements appears.
   A BIB design is also called a (b, v, r, k, λ)-configuration.

BIB designs have a property of full covering. A given set is fully covered by the subsets. The number of subsets in BIB design can not be less than number of elements in primary set −b≦v [2].

(prior art) In order to guarantee the most economical coverage of a given set by subsets, the condition b=v (and hence r=k) should hold. Such type of combinatorial designs is called symmetrical BIB designs. For the sake of illustration consider a set X={x₁,x₂,x₃,x₄,x₅,x₆,x₇,x₈,x₉}. A symmetrical BIB design, called (7, 7, 3, 3, 1)-configuration, constitutes a collection of subsets bᵢ=1, 2, . . . , 7 as shown by the columns of the table shown in FIG. 1.

As an example of computer application of combinatorial designs, FIG. 2 (prior art) shows a schematic diagram of a REBUS microprocessor architecture. Also see U.S. Pat. No. 5,619,680—Berkovich (co-inventor). In the FIG. 2 (prior art) example every object is stored in three copies over the processor nodes. Suppose an exchange of information has to occur between registers #3 and #5, resulting that register #5 has been changed. Due to pairwise balanced distribution of objects there is a processor node where these registers coexist, in this case it is node 6. Thus, this pair of registers can interact right after creating new versions of the registers without moving data across the communications links. Information updates are sent through corresponding bus delivering a new version of register #5 to corresponding processor nodes: 5, 6, and 1. This organization of communications allows the information exchange in the whole system of objects to run concurrently. One of the significant applications of combinatorial interconnections with replicated objects presents the REBUS (Regulated Elements By Universal Scheme) processor architecture[8].

The property of pairwise balance in REBUS microprocessor architecture guarantees, that for any given pair of registers there are exist exactly A processing elements, where an operation on these registers can be performed.

The property of full covering in REBUS microprocessor architecture guarantees that any memory address in any memory block is accessible from any processing element.

Combinatorial designs have not, to the knowledge of inventors, been applied to the problem of router development.

The use of parallel routers having architectures based other than on combinatorial designs principles is known. Unlike such architectures, the proposed one offers a better trade-off between complexity and performance.

The property of pairwise balance in combinatorial routing architecture guarantees that for any pair of input and output channel there is exactly λ processing elements, connected to the given pair of channels. The trivial case when a packet, arrived through an input channel is designated to the output channel with the same number means a route loop. Such packets are discarded without routing. The property of full covering guarantees that a packet can be designated to any output channel and also that a packet can be designated to any number of output channels simultaneously.

### BRIEF DESCRIPTION OF THE DRAWINGS

FIG. 1 (prior art) is a table presents an example of symmetric BIB design.

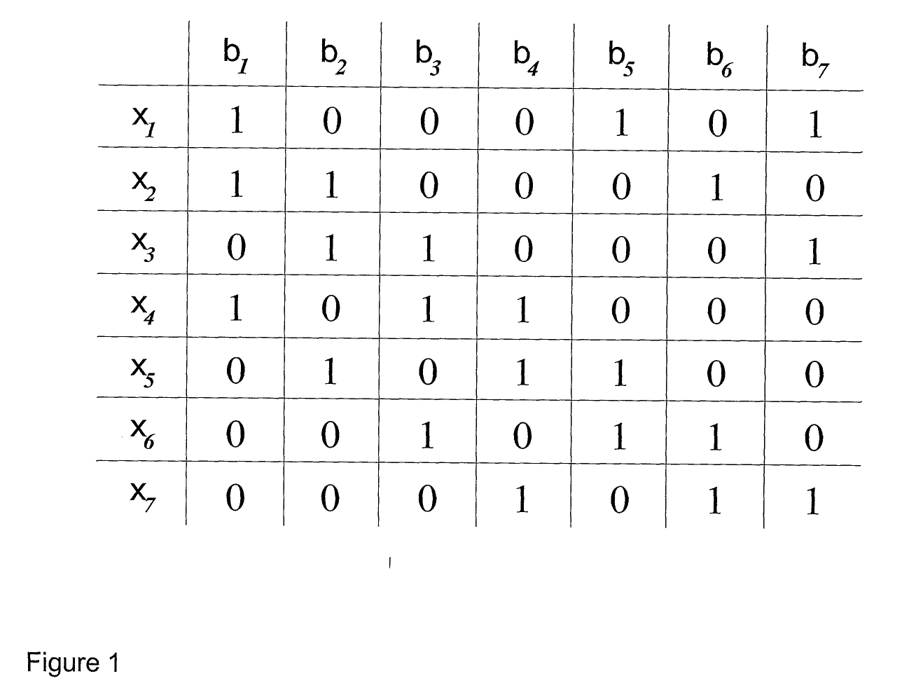

FIG. 2 (prior art) is a schematic diagram of a REBUS microprocessor architecture.

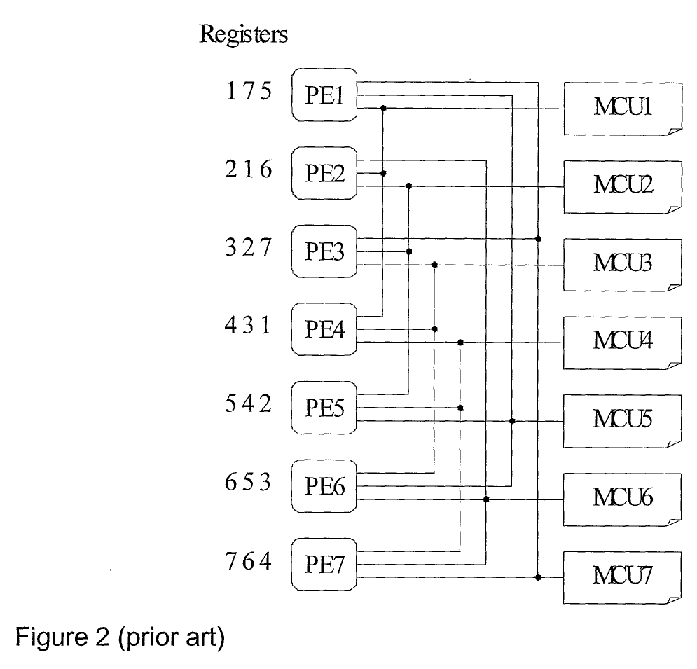

FIG. 3 is a table showing some possible symmetric BIB designs for A equals to 1.

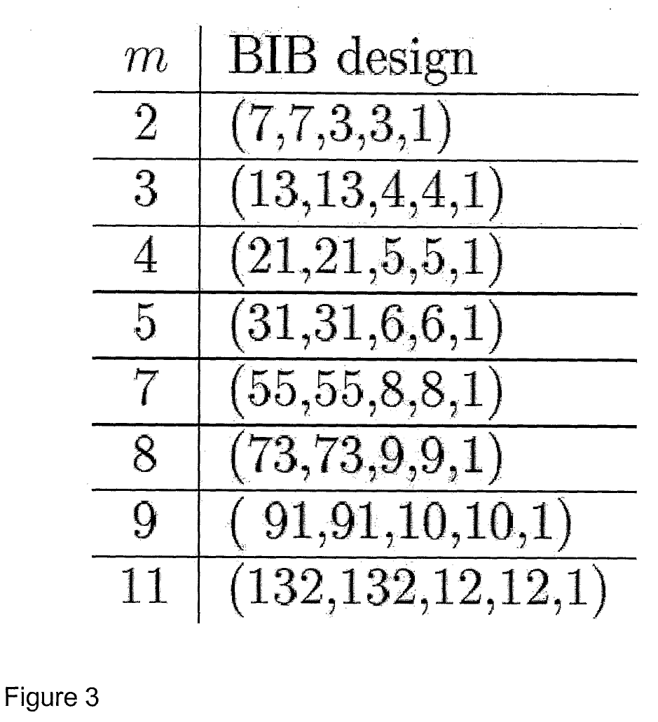

FIG. 4 is a schematic diagram of a combinatorial (7, 7, 3, 3, 1) router according to the inventions. Contention resolution is performed by a priority schema (not shown).

FIG. 5 is a schematic diagram of a combinatorial (7, 7, 3, 3, 1) router according to the inventions. Contention resolution is performed in output buffers.

FIG. 6 is a schematic diagram of a combinatorial (7, 7, 3, 3, 1) router according to the inventions. Contention resolution is performed by a crossbar switch.

FIG. 7 is a schematic diagram of a combinatorial (15,15,7,7,3) router according to the inventions.

FIG. 8 is a schematic of Internet routing (Spanning Tree Algorithm applied).

FIG. 9 (prior art) is a schematic diagram of the architecture of a single processor router.

FIG. 10 (prior art) is a schematic diagram of a crossbar parallel switching router.

FIG. 11 (prior art) is a schematic diagram of a router with shared processor pool.

### DETAILED DESCRIPTION

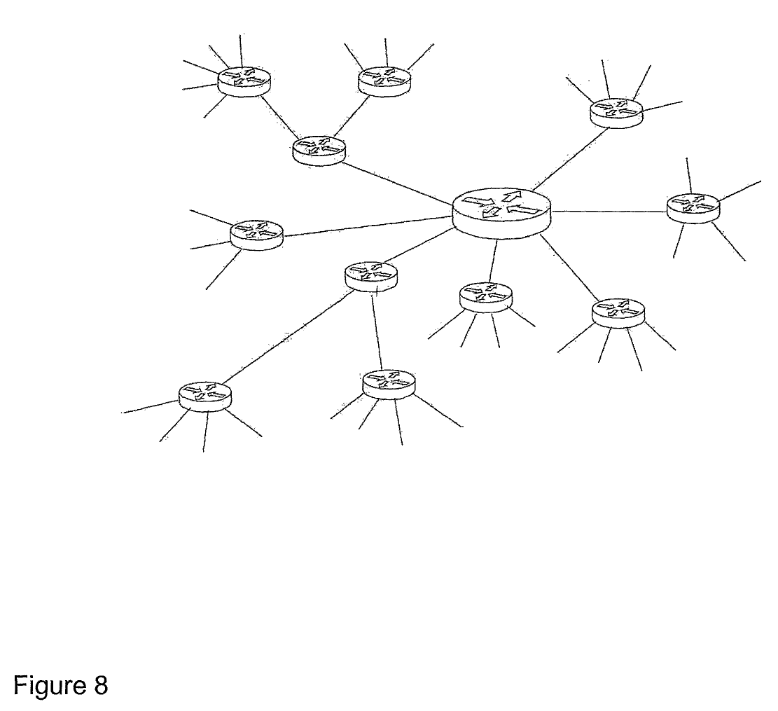

FIG. 8 is a schematic diagram of the Internet as a network of routers with a spanning tree algorithm applied. Routers according to the designs presented herein could be substituted for any (and all) of the routers in the network. A main practical application of the router designs described herein would be to use them as “medium class” routers where application of existing parallel routing architectures is not economically justified and/or multicast functionality is desired and a single processor router can not process the traffic.

A router is a special purpose computer or a computer program, which handle the communication of packet-switched networks. They play a decisive role in computer network, particularly Internet, sometimes called a network of routers (see, e.g. [3, 4]).

Packet-switched networks employ the idea of splitting big data blocks to be sent from one node of the network to another onto smaller chunks named packets and handle these packets each individually. The nodes need not to be connected directly; it is presumed that you will find one or more intermediate nodes on the way from the source to the destination. Packets travel independently through the chain of intermediate nodes performing routing, until they reach the destination.

The router operations are usually split onto three independent processes: 1) path determination; 2) packet switching; and 3) administration and control. The process encounters local problems inside the routers like next hop determination and global problems of optimal channel assignments for information flows between the nodes. Some problems are not related to the routing itself, like packet queues, network security or routing tables management. The Basic Reference Model of the Open Systems Interconnection (OSI) specifies seven layers of network communications organization (see, e.g. [4]). From the OSI Model point of view a router is a network layer device that uses certain metrics to determine the optimal path to dispatch the traffic.

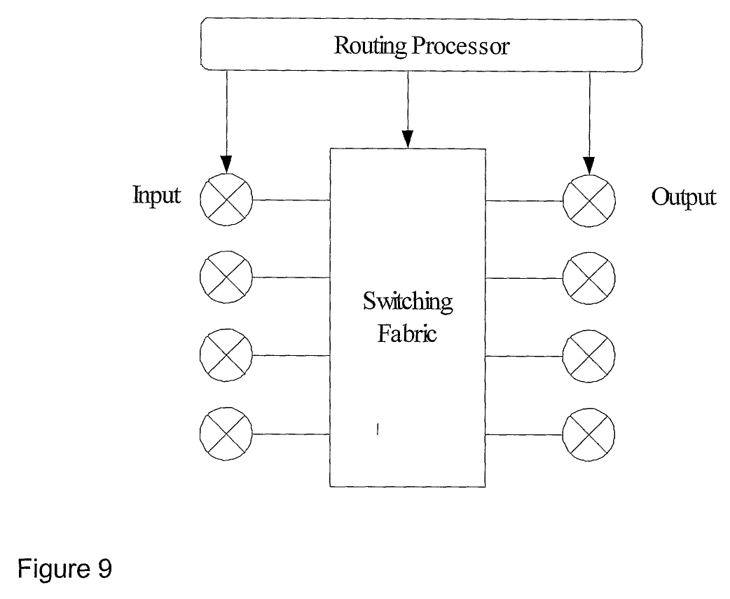

FIG. 9 is a schematic diagram of a generic router which has four architectural components: input ports receiving data, output ports transmitting it, switching fabric which interconnects input ports with output ports and routing processor which performs coordination and control [5]. Although actions of these components are to be coordinated, their operations basically can run independently. Input and output ports are usually joint in a component named line card. Besides transmission itself, a line card is usually performing other jobs like buffering the data.

The main function of a router is to move a packet from an input channel to one of the output channels, which requires intensive processing activities or application-specific integral circuits for switching. The switching in its turn needs control and it necessitates extensive computation performed practically in real time.

The other-than-routing processing may involve blocking certain packets or modifying their transport headers and information contents. As the number of services which system administrators expect to find at the routers grows, the more powerful router hardware needs to be deployed. Thus the continuous growth and evolution of the Internet heavily overloads traffic handling facilities and demands for router devices of higher performance.

Routers have to maintain a substantially large table that reflects the state of the routes in the whole Internet, neighbor routers and channels between them. This look-up table is searched to determine an optimal destination line for packet transmission. Within Internet domain this table is named Forwarding InfoBase (FIB)[6]. The table contains route prefixes of variable length. An IP address can match multiple prefixes and the destination port is determined by the longest prefix matched. While the direct lookup algorithms can perform as fast as O(1), they require significant computation for insertion/update (up to O(N), where N is the number of possible IP addresses, 2³² for IPv4 and 2¹²⁸ for IPv6) to create lookup tables necessary for these algorithms to work.

More flexible algorithms using Radix trie and variants, as well as compressed trie and binary search on prefix intervals can perform lookup and update with complexity as low as O(W), where W is the number of address bits (32 for IPv4 or 128 for IPv6).

Internet traffic can be characterized as generally non-uniform [7]. Over the time the users' interests are shifted from one host to another, generating funnel flow toward the attraction source. These bursts could create excessive load on the routing elements, but fortunately the number of source-destination pairs are limited and so a caching technique could be very beneficial. Once a destination route has been determined, the router can put the destination address along with destination port index into a cache. Any subsequent packet should be first checked against cache to find if there was a similar packet routed.

To make use of caching a parallel router should possess a property of persistence. If a processing element had performed routing for a packet, the successor packets should be processed by the same processing element. The funnel shape of traffic obviously has a bottleneck in the output channel, where multiple packets are competing for the same port and create blocking conditions. We could distinguish in the routers input blocking, output blocking and head-of-line (HOL) blocking[8]. Input blocking occur if a processing element or output port is busy while a new packet has arrived. Output blocking is occur if an output port is busy, while another packet is ready for the transmission.

In order to resolve input and output blocking conditions routers apply queuing. A queue could be implemented in a port, or in processing element memory. In the last case the queue is attributed as virtual. Output queuing creates another blocking condition, named head-of-line blocking. Head-of-line blocking occur, if the first packet in a queue is designated to a busy port, while there are other packets in queue, designated to an available port.

Modern Internet can be characterized as highly volatile and hostile environment. Besides targeted attacks against network infrastructure, like Denial of Service (DoS), network worms and viruses could overload the routers as a side effect of their activity. According to [9], routing table updates can stimulate excessive computation, so routers have to have some spare computation power to sustain such challenge. Also we could analyze if a router is capable to perform its operation if an attacks involves only part of the connected channels.

The performance of a router is characterized by two values. Throughput is the number of packets/bytes a router can pass through from input to output in a time unit. It is obvious that router throughput should not be less than the sum of throughput of connected channels. Latency is delay between the moment a packet arrives an input port and the moment it leaves an output port.

The complexity could be assessed as the number of processing element and internal buses as a function of the number router channels.

To illustrate different approaches to solve routing problems in this work we will analyze three existing routing architectures and propose a new one.

The shared memory architecture utilizes common RAM (Random Access Memory) as switching fabric (FIG. 9). Among other advantages it can be easily implemented with a universal computer and allows to have the lowest possible cost per port. Its performance is limited by the memory bandwidth used by all input, output operations and the CPU (Central Processing Unit) accessing data and program.

Only a packet header should be copied into common RAM, while the line card holds entire packet while processing. During the discussion we omit inter-card connections for the sake of simplicity.

Considering only routing and switching operations with no FIB management overhead we could determine the upper limit of the throughput. Assume FIB lookup algorithm has complexity of O(w), where w is the address width, the packet header has the length of 1 words in memory and given memory bus speed of F MHz, there is a number of packets a router can process in one second defined by T=F/(l+w). The sum (l+w) represents the number of memory bus cycles necessary for a packet processing.

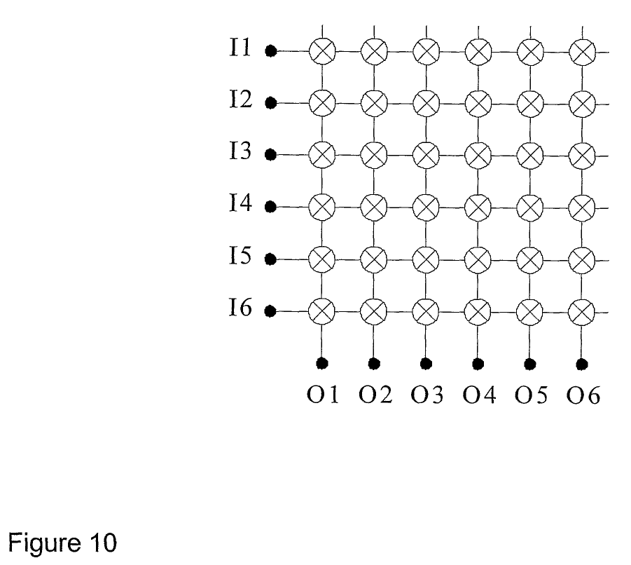

FIG. 10 (prior art) is a schematic diagram of a crossbar parallel switching router. To increase the router performance we can equip every pair of input/output channels with an independent PE. Assuming no contention occur we could tell that the router throughput could not be more than T·N, where N is the number of channels.

The router complexity is equal to N² PEs, where N is the number of channels. Besides that, contention resolution could easily make a crossbar router impractical.

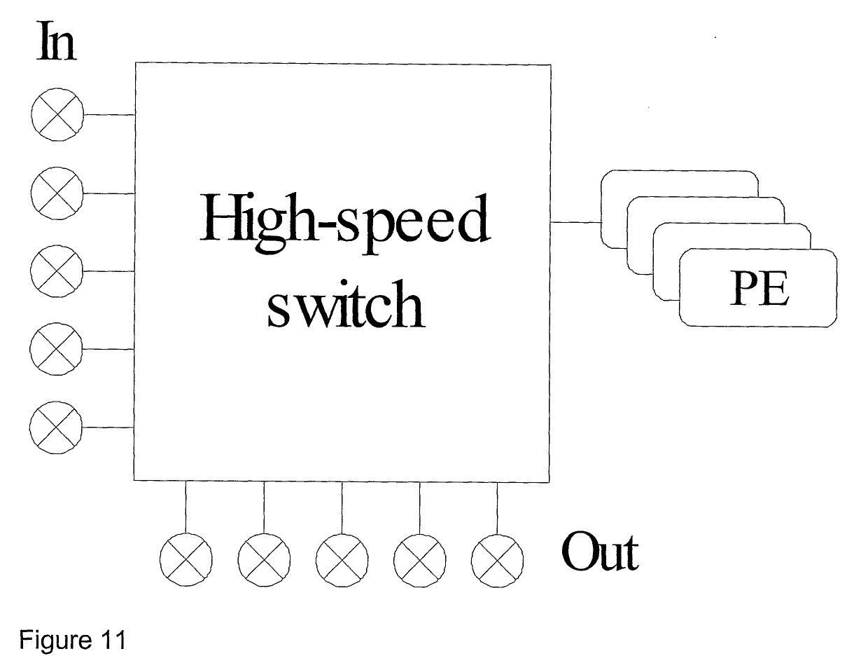

Faster routers can be made using shared parallel processor pool [10] (see FIG. 11). While a single PE can not perform routing fast enough, a pool of PEs can process at any necessary speed. A packet arrived is stored in the input interface. The interface transmits the packet header to the next available PE through the interconnection circuitry. PE responds with the appropriate output interface number so the input interface can transfer the whole packet to it. Thus the slower process of routing can be dynamically spread among multiple processing units and actual packet forwarding is performed by a fast switch. Currently it is custom to use as the core switch an ATM (Asynchronous Transfer Mode) based device.

Because of extensive development and availability of ATM hardware components, they are widely used in routers [5] and it creates a problem with multicast traffic. A multicast packet may be destinate to several output interfaces at once so the input interface should arrange multiple transmissions which delays other input or output packets processing until all transmissions are over. It also increases the latency as the packet for the output channel which happen to be the last in queue will be delayed until all other ports will receive it. More complex switching fabric like crossbar switches could mitigate the problem, but unfortunately, the implementation of advanced scheduling algorithms like iSLIP and ESLIP [11] requires a scheduler which should outperform entire processor pool. Giving that the processor pool is working at the maximum economically reasonable speed, we have a performance bottleneck at the scheduling stage.

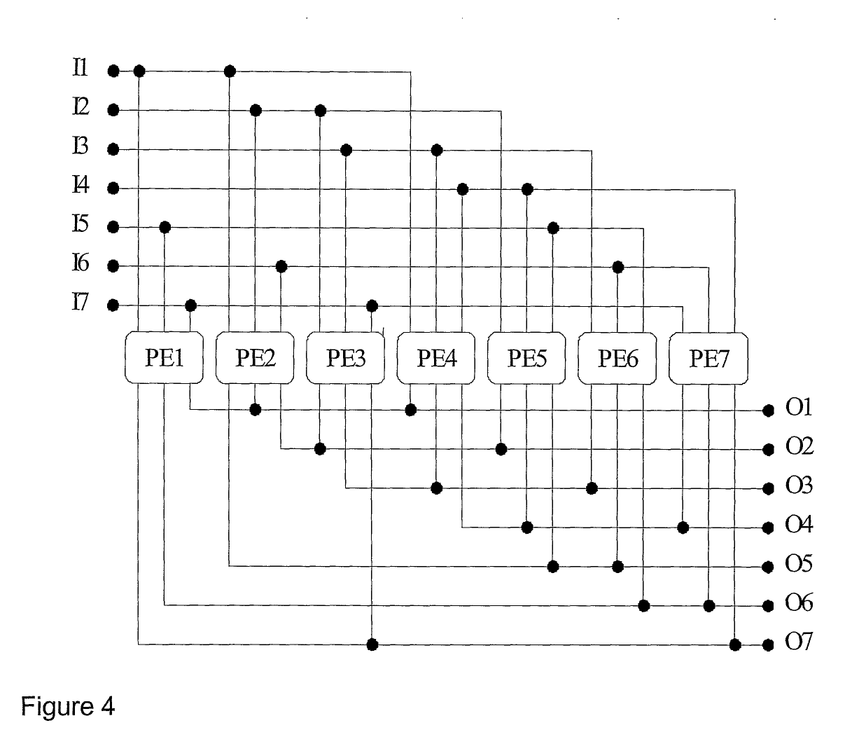

FIG. 4 is a schematic diagram of a seven channel combinatorial (7, 7, 3, 3, 1) router according to the inventions. This is an exemplary embodiment of a router resulting from the application of combinatorial design principles to the router design problem. In case of (7, 7, 3, 3, 1) router each PE has one input channel, a memory module, a CPU and three output channels. Initially all the PEs should be loaded with the routing information. Each of PEs contains a part of the complete routing table corresponding channels directly connected to the PE.

Assume a packet came from the input interface 12 and should be routed to the interface O5. The interface 12 is connected to the processing units PE2, PE3 and PE5 with the line 2. All of the units listed start search the route to the destination in their routing tables. Processing units PE2 and PE3 fail as they have no route to O5. PE5 has the route listed in its routing table and it forwards the packet received to the O5.

There is an ambiguity if a packet must be routed to a destination channel with the same sequence number as the source channel. It may happen, for example, if there is a loop in the routing table, there is a downstream router mis-configuration or an address spoofing attack happen. In this case the packet should be dropped with possible notification of the sender.

Due to the distributed nature of processing the suggested design has better resistance to overloads while Denial of Service (DoS) attacks or global routing instability. While overload of any of the channels is fatal for a traditional single-processor, shared-bus and shared-memory router, the combinatorial design router remains mostly operational even some of the channels and PEs get clogged.

Speed and reliability are the primary goals while designing backbone routers [5]. We already discussed the method which allows to create routers of any performance even the necessary throughput exceeds physical capabilities of hardware used to perform routing. Let us increase the reliability as the combinatorial designs offer great flexibility if we need a redundant scheme.

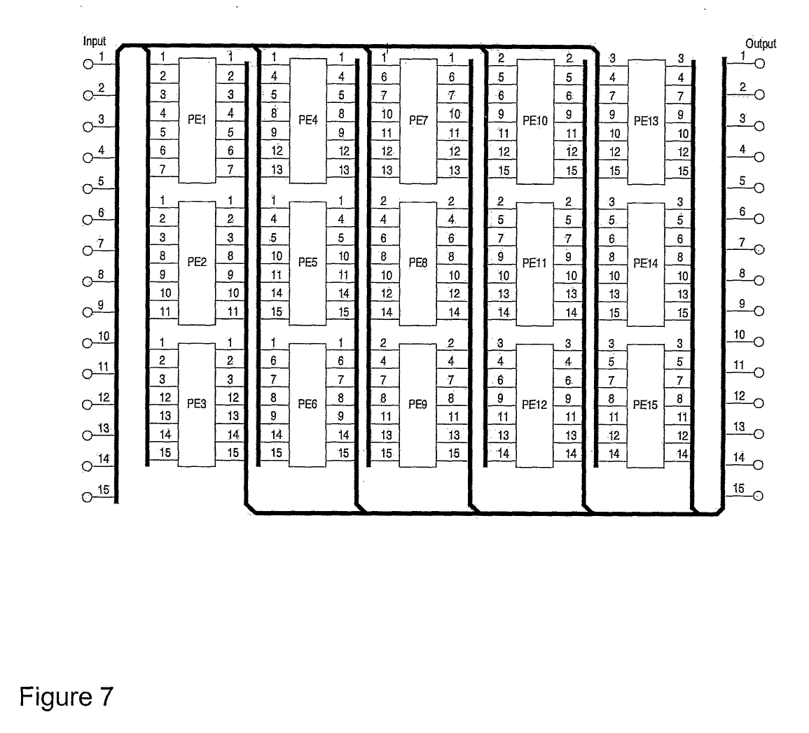

FIG. 7 is a schematic diagram of a combinatorial (15,15,7,7,3) router according to the inventions. Suppose we'd like to reserve a spare PE for each channel for the case of hardware failure. Adding this requirement to the problem of high speed routing, which we discussed, we'll have a combinatorial design (15,15,7,7,3) with the following properties: 1) The router has 15 input/output channels; 2) Any pair of input/output channels appear exactly in 3 PEs.

It can serve 15 channels with the throughput twice as much as the memory bandwidth, and sustain one failed PE per channel with no performance degradation. By specifying higher X (the number of processing elements where any pair of channels meet), we can reserve as many PEs as we want if we are going to have greater reliability or speed. Please note that complete router failure will happen only if at least 3 PEs will come out of order.

FIG. 4 is a schematic diagram of a simplified seven channel combinatorial router that does not have a buffered output. For the sake of illustration, contention resolution signaling is not shown.

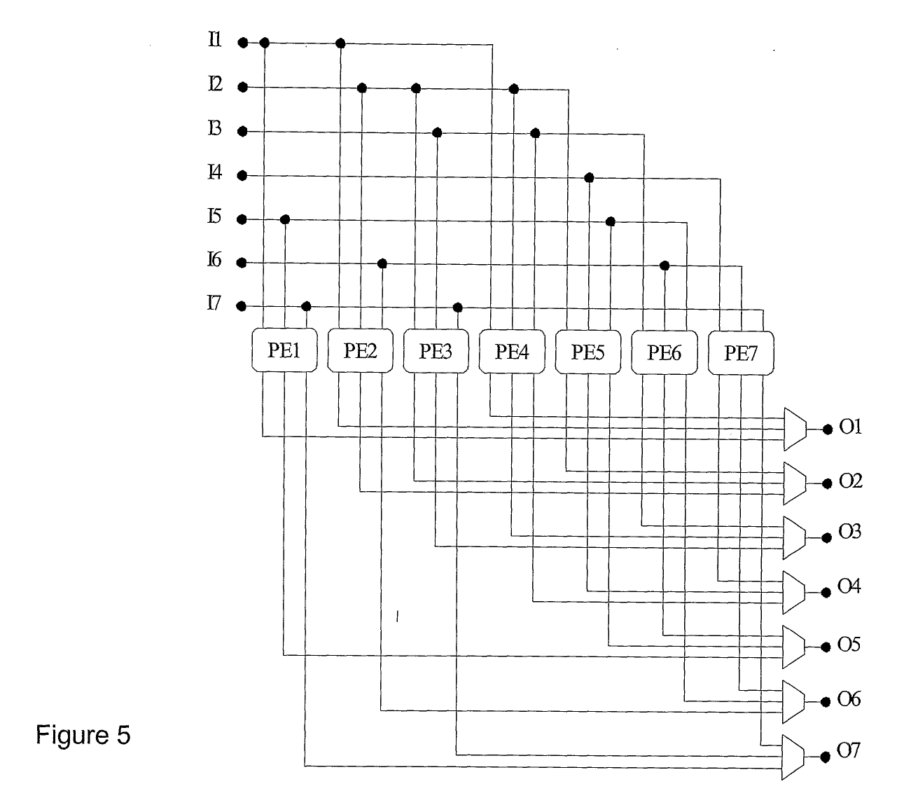

FIG. 5 is a schematic diagram of a (7,7,3,3,1) combinatorial router having buffered output. Each of the output channels is equipped with a three-input port buffer. Every processing element (PE1 . . . PE7) could perform independent writing to the output channel buffer. Any further queuing and arbitration is performed within the buffer.

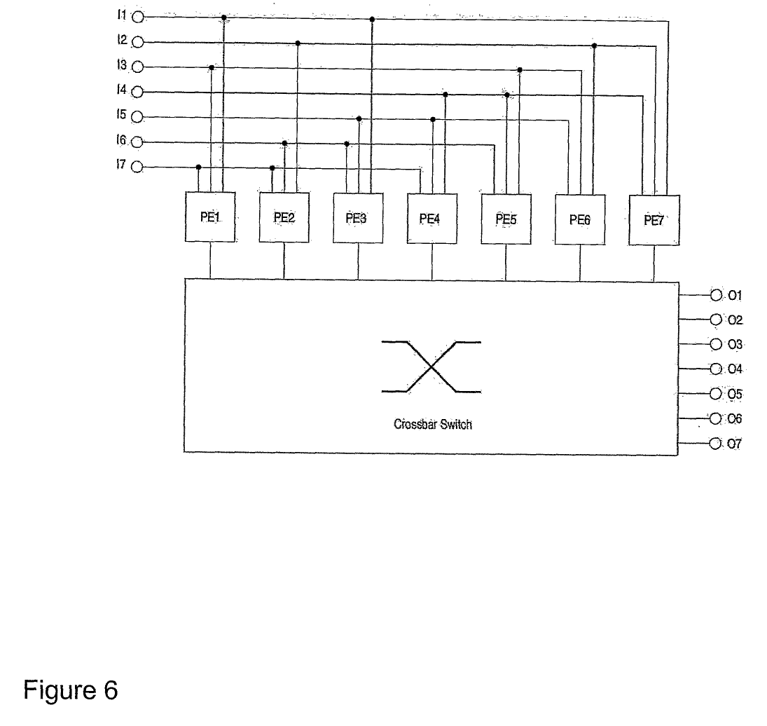

FIG. 6 shows an embodiment of (7,7,3,3,1) combinatorial router with crossbar switch. In this embodiment, contention resolution is carried out by a crossbar switch. Routing is performed by processing elements with reduced/partial forwarding information base (FIB).

Router architectures based on combinatorial designs represent a reasonable tradeoff among cost, complexity and performance. They provide performance gains that come from 1) shorter forwarding Info base; 2) smaller number of input channels in every processor element; and 3) pre-scheduling by spreading processing based on the hard wiring of processors. Combinatorial design routers provide 1) effectual pre-processing scheduling using bare wires; 2) simple multicast implementation; 3) simplifying more complex architecture development given extra requirements like performance or reliability; 4) effectual switching capabilities.

1. A router architecture based on combinatorial design, comprising:
A plurality of input channels;
a plurality of processing elements;
a plurality of output channels; and
buses interconnecting the input channels, processors, and output channels in a manner such that:
each pair of channels exists in only a pre-selected number of processor (pairwise balance property)
subsets of output channels, connected to processing elements. covers entire set of output channels (full covering property)

2. A router according to claim 1 further comprising a crossbar switch to resolve output contention.

3. A router according to claim 1 further comprising output buffers to resolve output contention.

4. A router according to claim 1 further comprising a prioritizing schema (like round-robin or any other) to resolve output contention.
